(19) United States
(12) Patent Application Publication
(10) Pub. No.: US 2014/0204576 A1
(43) Pub. Date: Jul. 24, 2014

(54) REFLECTIVE ELECTROOPTIC LIGHTING DEVICE

(71) Applicants: XIAO-MING JIN, BANGKOK (TH); TAO JIN, SHANXI PROVINCE (CN); NATHAN HENRY LAM, NEW SOUTH WALES (AU)

(72) Inventors: XIAO-MING JIN, BANGKOK (TH); TAO JIN, SHANXI PROVINCE (CN); NATHAN HENRY LAM, NEW SOUTH WALES (AU)

(21) Appl. No.: 14/153,345

(22) Filed: Jan. 13, 2014

(30) Foreign Application Priority Data
Jan. 18, 2013 (TW) 102201227

(51) Int. Cl. F21V 7/00

(52) U.S. Cl. CPC F21V 7/00
USPC 362/235

(57) ABSTRACT

A reflection lighting device comprises a reflective member including a transforming plate and a reflective mirror plate, and a supporting member, wherein the reflective member includes a transforming plate and a reflective mirror plate, and the reflective mirror plate is provided with an aperture, the transforming plate and the reflective mirror plate providing on the supporting member are oppositely facing to each other, and the light-emitting member is correspondingly facing to the reflective member. It makes the reflection of the light source become multiple reflections between the transforming plate and the reflective mirror so as to increase the brightness and the range of the illumination and to save the energy. The reflective electrooptic lighting device requires less space and can perform an optoelectronic transform function.

### FIELD OF THE INVENTION

The present invention relates to an electrooptic lighting device, and more particularly to a reflective electrooptic lighting device.

### BACKGROUND OF THE INVENTION

Nowadays, the irradiation of the light emitted from the lighting device used in various places is mostly unidirectional. Therefore, there are limitations for increasing the utilization rate of the light source and for improving the efficacy of the lighting. In order to satisfy the users about the requirement of the intensity of the illumination, it is common to increase the quantity of the installed lighting device. It thus not only increases the cost expense for installation of the light device, but also it is more power consumptive since it requires to use power with a huge power voltage. Moreover, it further causes more unsafe factors which may cause the damage and then may result in the power failure for a considerable wide region. In consideration of efficiency in space, when a more sufficient illumination is required, a larger space is required to allocate a larger lighting device. Therefore, it becomes an important issue regarding how to enhance the efficacy of luminance and to make the lighting device safer and more environment-friendly.

### SUMMARY OF THE INVENTION

Thereby, an object of the present invention is to provide a reflective electrooptic lighting device that overcomes the defects existing in the prior arts by increasing the efficacy of luminance so as to save the energy.

The present invention overcomes the drawbacks of the prior art, and provides a reflective electrooptic lighting device, which comprises a light-emitting member, a reflective member and a supporting member, wherein the reflective member includes a transforming plate and a reflective mirror plate, and the reflective minor plate is provided with an aperture, the transforming plate and the reflective mirror plate providing on the supporting member are oppositely facing to each other, and the light-emitting member is correspondingly facing to the reflective member.

In a preferred embodiment of the present invention, it further comprises a plurality of reflective mirrors provided on the transforming plate.

In a preferred embodiment of the present invention, the transforming plate is a reflective plate, the supporting member is a transparent cover, and it further comprises a lens and a plurality of reflective mirrors provided on the reflective mirror plate.

In a preferred embodiment of the present invention, it further comprises a transparent plate extending outward from the reflective mirror plate, and a lens is provided on the reflective mirror plate.

In a preferred embodiment of the present invention, the light-emitting member has a plurality of LED light sources, a plurality of apertures are provided on the reflective mirror plate, and it further comprises a subsidiary plate provided on the transforming plate, the subsidiary plate has a reflective part and/or a transparent part.

In a preferred embodiment of the present invention, it further comprises a reflective stand provided between the transforming plate and the reflective mirror plate, a reflective column provided between the transforming plate and the reflective mirror plate, and a reflective pyramid provided between the transforming plate and the reflective mirror plate.

In a preferred embodiment of the present invention, the light-emitting member including a solar light source body, the transforming plate is provided with at least one electrooptic transforming member, a reflective mirror is provided on the back of the transforming plate, and the reflective mirror plate has a reflective part.

The light-emitting member of the present invention is provided between the transforming plate and the reflective mirror plate, where both of them are oppositely facing to each other. It makes the reflection of the light source become multiple reflections with wide range between the transforming plate and the reflective mirror plate so as to increase the efficacy of luminance. And particularly, the LED light is suitable for being used as the point light source of the reflective electrooptic lighting device. Even the light emitted for the point-style light sources in the reflective electrooptic lighting device are reflected several times to become the multiple light images. Therefore, the power source of the reflective electrooptic lighting device is especially suitable for solar power device, which is power supplied by a low power voltage. At the same time, a power supply of low power voltage can prevent any cause of the damage for power overloading or the cause of power failure and the cost in a unexpected wide region. A type of reflective electrooptic lighting device could not only require less space for installation, but also can enhance an optoelectronic transform function.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a perspective view illustrating the reflective electrooptic lighting device according to the first embodiment of the present invention;

FIG. 2 is a perspective view illustrating the transforming plate according to the first embodiment of the present invention;

FIG. 3 is a perspective view illustrating the reflective mirror plate according to the first embodiment of the present invention;

FIG. 4 is a perspective view illustrating the reflective electrooptic lighting device according to the second embodiment of the present invention;

FIG. 5 is a perspective view illustrating the reflective mirror plate according to the second embodiment of the present invention;

FIG. 6 is a perspective view illustrating the reflective electrooptic lighting device according to the third embodiment of the present invention;

FIG. 7 is a perspective view illustrating the reflective electrooptic lighting device according to the fourth embodiment of the present invention;

FIG. 8 is a perspective view illustrating reflective mirror plate according to the fourth embodiment of the present invention;

FIG. 9 is a perspective view illustrating the reflective electrooptic lighting device according to the fifth embodiment of the present invention;

FIG. 10 is a perspective view illustrating the transforming plate according to the fifth embodiment of the present invention;

FIG. 11 is a perspective view illustrating the reflective mirror plate according to the fifth embodiment of the present invention;

FIG. 12 is a perspective view illustrating the reflective electrooptic lighting device according to the sixth embodiment of the present invention;

FIG. 13 is a perspective view illustrating the transforming plate according to the sixth embodiment of the present invention;

FIG. 14 is a perspective view illustrating the reflective mirror plate according to the sixth embodiment of the present invention.

### DETAILED DESCRIPTION OF THE PREFERRED EMBODIMENTS

### The First Embodiment

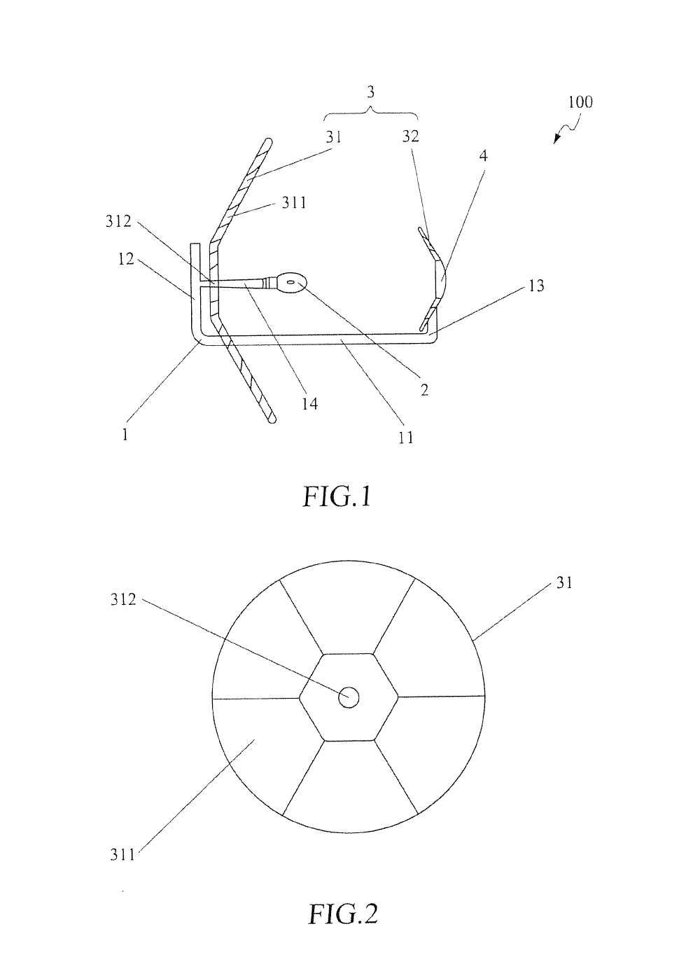

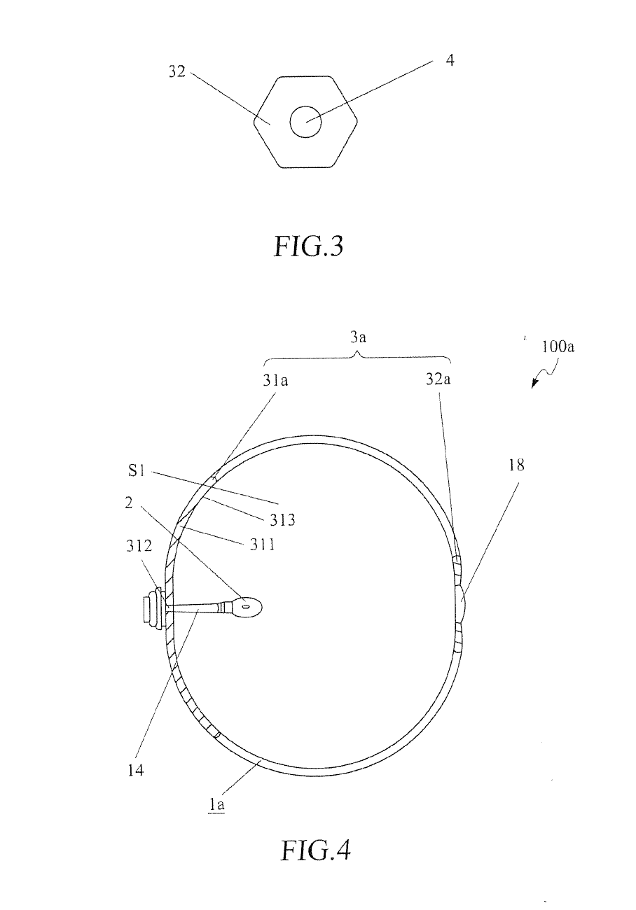

A reflective electrooptic lighting device 100 of the present invention is shown in FIG. 1. A transforming plate of the reflective electrooptic lighting device 100 is shown in FIG. 2. A reflective mirror plate of the reflective electrooptic lighting device 100 is shown in FIG. 3. The reflective electrooptic lighting device 100 comprises a supporting member 1, a light-emitting member 2, and a reflective member 3. The reflective member 3 includes a transforming plate 31 and a reflective mirror plate 32. The reflective mirror plate 32 is provided with an aperture 4. The transforming plate 31 and the reflective mirror plate 32 are both provided on the supporting member 1. And the transforming plate 31 and the reflective mirror plate 32 face oppositely to each other. The light-emitting member 2 is disposed between the transforming plate 31 and the reflective mirror plate 32, and the light-emitting member 2 is correspondingly facing to the reflective member 3.

The supporting member 1 includes a primary rod 11, a first branch rod 12, a second branch rod 13, and a light rod 14. The first branch rod 12 and the second branch rod 13 are provided on the two ends of the primary rod 11 respectively. The light rod 14 is disposed on the first branch rod 12 and is parallel to the primary rod 11.

As shown in FIG. 2, the transforming plate 31 includes a plurality of the reflective mirrors 311, and in the central of the transforming plate 31 there is a central aperture 312 for light rod 14 to pass through.

Refer again to FIG. 1, the light rod 14 passes through the central aperture 312 of the transforming plate 31. The reflective mirror plate 32 is fixed on the end of the second branch rod 13 of the supporting member 1. The light-emitting member 2 is disposed on the end of the light rod 14.

In this embodiment, the light-emitting member 2 is a LED lamp, and light-emitting member 2 may also be an incandescent lamp, a fluorescent lamp or a lamp with a cover covering the LED lamp or the incandescent lamp.

The streams of the light emitted from the light-emitting member 2 are not only refracted outward by the plurality of the reflective mirrors 311 on the transforming plate 31, but also pass through the aperture 4 then illuminate forward of the aperture 4. The other streams of the light emitted from the light-emitting member 2 which is on the periphery of the aperture 4 are reflected repeatedly on the transforming plate 31 and then illuminate outward to enhance the efficacy of the light emitted from the light-emitting member 2. In this embodiment, the transforming plate 31 is made of a retroreflective material, thereby the reflective efficacy increases and thus the intensity of illumination increases.

### The Second Embodiment

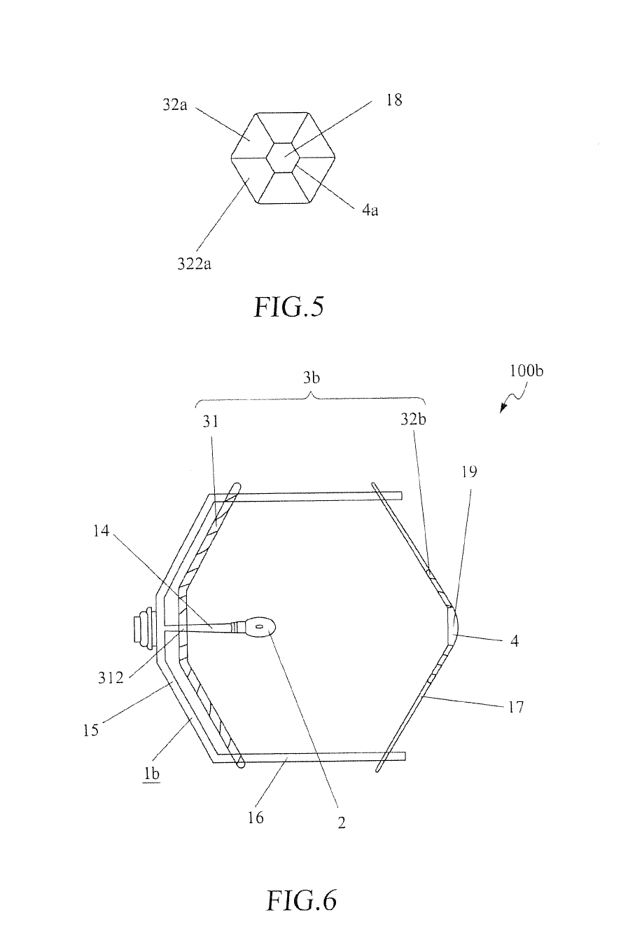

A reflective electrooptic lighting device 100a of the present invention is shown in FIG. 4. A reflective mirror plate of the reflective electrooptic lighting device 100a is shown in FIG. 5. The elements of this embodiment illustrated in these two Figs. are similar to those in the first embodiment. The second embodiment is different from the first embodiment as follows. The supporting member 1a is a transparent cover, and the transforming plate 31a is a reflective mirror. The transforming plate 31a and the reflective mirror plate 32a are provided on the two ends of the supporting member 1a respectively. The reflective mirror plate 32a includes a plurality of the reflective mirrors 322a, and a lens 18 is disposed on the edge of the aperture 4a of the reflective mirror plate 32a. The lens 18 may be fixed on the edge of the aperture 4a by interlocking. And the connection between the supporting member 1a, transforming plate 31a, and the reflective mirror plate 32a is sealed and waterproof so as to form a sealed space S1. in this embodiment, the shape of the supporting member 1a is bucket-shaped and has an opening to joint the transforming plate 31a and the reflective mirror plate 32a, and the supporting member 1a also may be a cube-shaped configuration with a opening, or the like. The light rod 14 is inserted into the sealed space S1 through the central aperture 312 of the transforming plate 31a.

The illumination style of the light-emitting member 2 disposed in the space S1 of this embodiment is similar to the one in the first embodiment. The second embodiment is different from the first embodiment as follows. In addition to the streams of the light focused by the lens 18 and then pass forward through the lens 18, the other streams of the light refracted by the transforming plate 31a and the reflective mirror plate 32a all pass outward through the supporting member 1a. And since the reflective electrooptic lighting device 100a is sealed and waterproof, it is suitable to be used outside or in the moist environment. In this embodiment, the transforming plate 31a is provided with an electrooptic transforming member 313 on its side oppositely facing the reflective mirror plate 32a. For example, the electrooptic transforming member 313 may be a solar panel which is coated with conductive layer, such as aluminium layer and copper glue, and electively connects with an electricity storage device (not shown). Thereby the light energy received by the electrooptic transforming member 313 of the transforming plate 31a can be transformed as electric energy for further storing in the electricity storage device. Moreover, the supporting member 1a can be a light filter so as to protect the electrooptic transforming member 313 of the transforming plate 31a from the strong solar light that is very strong and is outside of the reflective electrooptic lighting device 100a.

### The Third Embodiment

A reflective electrooptic lighting device 100b of the present invention is shown in FIG. 6. The elements of this embodiment illustrated in the Fig. are similar to those in the first embodiment. The third embodiment is different from the first embodiment as follows. The reflective electrooptic lighting device 100b further includes: a bottom plate 15 for allowing a light rod 14 of the supporting member 1b to dispose thereon, a plurality of the third branch rods 16 spaced at intervals and surrounding around the bottom plate 15, and a transparent plate 17 extending from the reflective mirror plate 32 and disposed on the ends of the plurality of the third branch rods 16. The transforming plate 31 is provided on the bottom plate 15 of the supporting member 1b, and the light rod 14 is inserted in the central aperture 312 of the transforming plate 31.

The illumination style of the light-emitting member 2 of this embodiment is similar to the one in the first embodiment. The third embodiment is different from the first embodiment in as follows. The streams of light-emitting members 2 are focused by a flat lens 19 and then pass forward through the flat lens 19. The transparent plate 17 is disposed in the front of the transforming plate 31 so as to prevent from the discomfort due to the direct illumination emitted by the light-emitting member 2. Of course, the present invention is not limited for this. The transforming plate 31 of this embodiment can be one as similar with the transforming plate 31 of the first embodiment or the transforming plate 31a of the second embodiment that has the retroreflective material and the electrooptic transforming member. And the transparent plate 17 can be a light filter for protecting the electrooptic transforming member on the transforming plate 31.

### The Fourth Embodiment

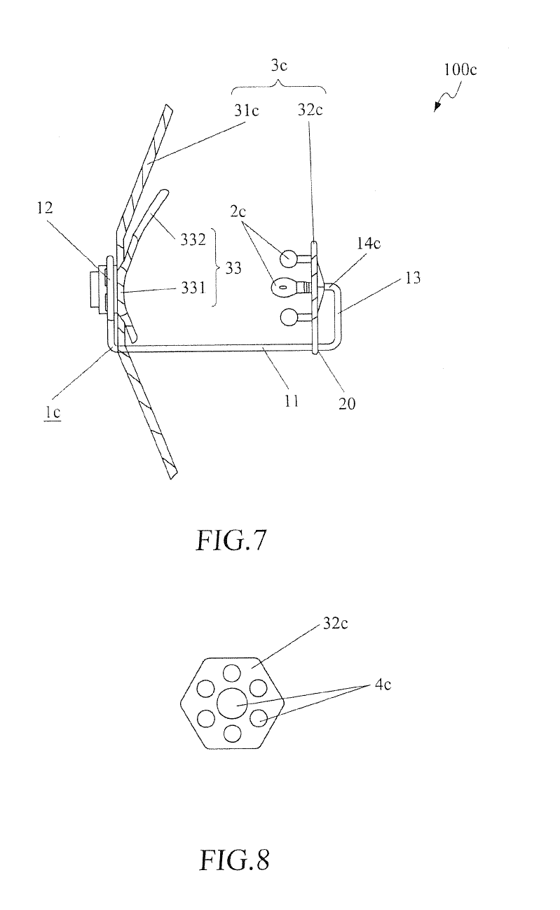

A reflective electrooptic lighting device 100c of the present invention is shown in FIG. 7. The reflective mirror plate of the reflective electrooptic lighting device 100c is shown in FIG. 8. The elements of this embodiment illustrated in these two Figs. are similar to those in the first embodiment. The fourth embodiment is different from the first embodiment as follows. A subsidiary plate 33 is provided on the central of the transforming plate 31c. The subsidiary plate 33 has a reflective part 331 for reflecting the light and has a transparent part 332 for the light passing, wherein the transparent part 332 is a flat lens, a convex lens, or a concave lens. The subsidiary plat 33 may be some types of the plat as follows. The streams of the light of a specific wavelength can pass through or be reflected form the subsidiary plat 33; the subsidiary plate 33 may be a transparent plate or a transforming plate, wherein the transforming plate may be the flat transparent plate, the convex transparent plate, and the concave transparent plate. A light rod 14c parallel to the primary rod 11 is provided on the end of the second branch rod 13. A reflective mirror plate 32c with a plurality of apertures 4c is provided on a supporting point 20 on the primary rod 11. And the lights are emitted from a plurality of the light-emitting members 2c (as shown in FIG. 8).

The advantage of the illumination of this embodiment is as follows. The light emitted form a plurality of the light-emitting members 2c provided on the light rod 14c may be reflected from the reflective part 331 of the subsidiary plate 33 to the reflective mirror plate 32c, and then be reflected from the reflective mirror plate 32c to the transforming plate 31c, and then reflected outward from the transforming plate 31c finally. And partial of the light emitted form the light-emitting member 2c passes through a plurality of the apertures 4c on the reflective mirror plate 32c to illuminate forward. It makes the light emitted form the light-emitting member 2c being reflected three times so as to enhance the efficacy of the light emitted from the light sources. The transparent part 332 of the subsidiary plate 33 can change the focal length of the light emitted from the light-emitting member 2c or of the light reflected from the reflective mirror plate 32c to the transforming plate 31c, so as to change the efficacy of the light reflected from the transforming plate 31c. Of course, the present invention is not limited for this. The transforming plate 31c of this embodiment can be similar with the transforming plate 31 of the first embodiment or the transforming plate 31a of the second embodiment that has the retroreflective material and the electrooptic transforming member.

### The Fifth Embodiment

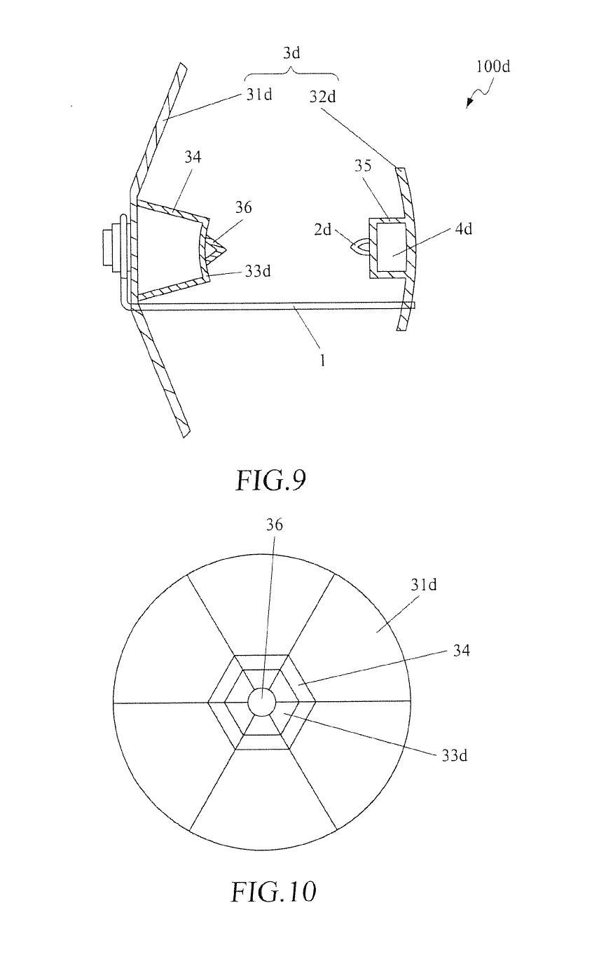

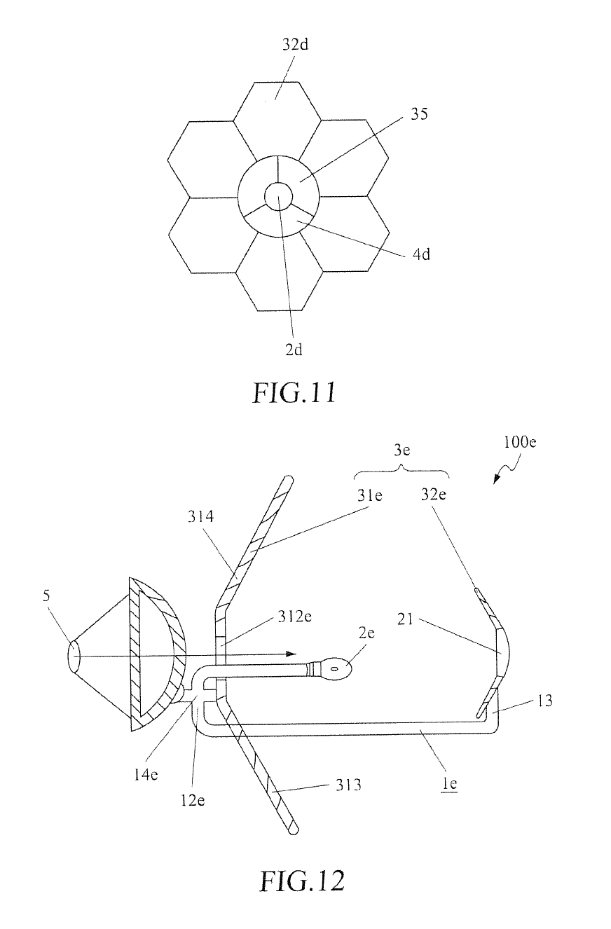

A reflective electrooptic lighting device 100d of the present invention is shown in FIG. 9. A transforming plate of the reflective electrooptic lighting device 100d is shown in FIG. 10. A reflective mirror plate of the reflective electrooptic lighting device 100d is shown in FIG. 11. The elements of this embodiment illustrated in these three Figs. are similar to those in the fourth embodiment. The fifth embodiment is different from the fourth embodiment in as follows. The reflective electrooptic lighting device 100d further includes a reflective stand 34 provided between the transforming plate 31d and the reflective mirror plate 32d, a reflective column 35 provided between the transforming plate 31d and the reflective mirror plate 32d, and a reflective pyramid 36 provided between the transforming plate 31d and the reflective mirror plate 32d. In detail, the reflective stand 34 is provided on the transforming plate 31d. The reflective stand 34 is provided with a subsidiary plate 33d thereon. The reflective pyramid 36 is provided on the subsidiary plate 33d. The reflective column 35 is provided on the edge of the aperture 4 of reflective mirror plate 32d, and the light can pass through or be reflected form the reflective column 35. A light-emitting member 2d is provided on the reflective column 35.

The reflective pyramid 36 reflects the light emitted from the light-emitting member 2d toward the periphery, then this light is reflected to the reflective mirror plate 32d together with the light reflected from the subsidiary plate 33d. These lights all pass into the reflective column 35 and then are reflected outward. The light reflected to the reflective mirror plate 32d is then reflected by the external part of the reflective column 35 and then returns to the transforming plate 31d. Finally the light is reflected by the reflective stand 34 again and then is reflected outward. Thereby the lights are reflected several times so as to enhance the efficacy of the light emitted from the light-emitting member 2d. Of course, the present invention is not limited for this. The transforming plate 31d of this embodiment can be similar with the transforming plate 31 of the first embodiment or the transforming plate 31a of the second embodiment that has the retroreflective material and the electrooptic transforming member.

### The Sixth Embodiment

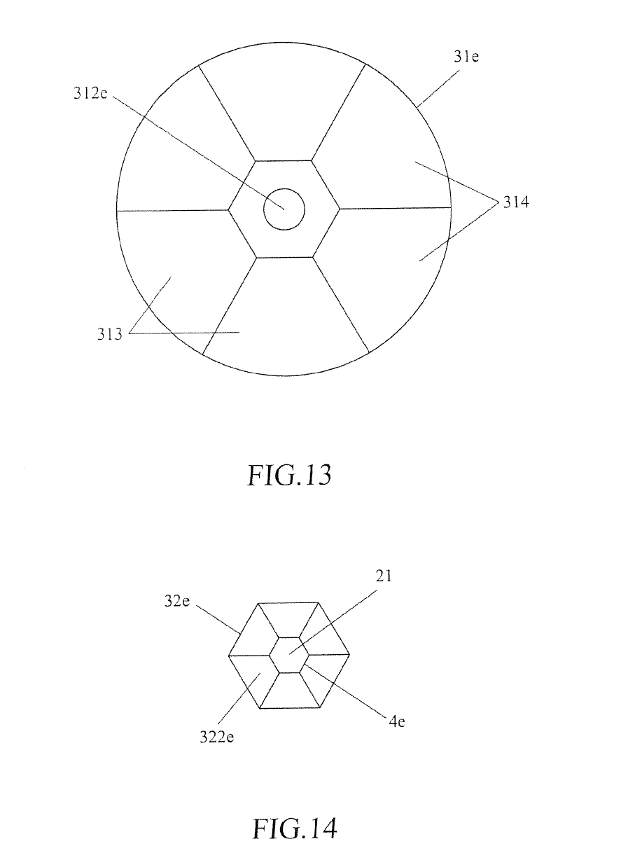

A reflective electrooptic lighting device 100e of the present invention is shown in FIGS. 12, 13, and 14. The elements of this embodiment illustrated in these three Figs. are similar to those in the first embodiment. The sixth embodiment is different from the first embodiment in as follows. The reflective electrooptic lighting device 100e further includes a light-emitting member 5 fixed on a light rod 14e connected with the first branch rod 12e of the supporting member 1e. In this embodiment, the light-emitting member 5 is a solar light source component for receiving solar energy. A transforming plate 31e of the reflective member 3e includes a plurality of the electrooptic transforming member 313. The back of the transforming plate 31e is provided with a reflective mirror 314. The reflective mirror 314 has a central aperture 312. The central aperture 312 can be provided with a lens, a flat lens, or a light filter. The reflective mirror plate 32e includes a plurality of reflective mirrors 322e (as shown in FIG. 14). The edge of the aperture 4e of the reflective mirror plate 32e is provided with a reflective part 21 (as shown in FIGS. 12, 14).

The characteristics of reflective electrooptic lighting device 100e of the sixth embodiment are: The light images emitted from the light-emitting member 2e can be reflected to a plurality of the electrooptic transforming member 313 by the reflective mirror plate 32e. And while the solar light focused by the light-emitting member 5 is projected on the reflective minor plate 32e, the solar light can be reflected to a plurality of the electrooptic transforming member 313 for further photoelectric transforming by the reflective mirror plate 32e. The light energy received by the electrooptic transforming member 313 of the transforming plate 31e can be transformed as electric energy for storing in the electricity storage device. And the transforming plate 31e with the reflective mirror 314 on its back can be reversed for illuminating. However, the present invention is not limited to that. The light-emitting member 5 also can be provided between the transforming plate 31e and the reflective mirror plate 32e. And the light-emitting member 5 also can be an incandescent lamp, a fluorescent lamp, or an ordinary lamp.

The above description should be considered as only the discussion of the preferred embodiments of the present invention. However, a person skilled in the art may make various modifications to the present invention. Those modifications still fall within the spirit and scope defined by the appended claims.

What is claimed is:

1. A reflective electrooptic lighting device, comprising a light-emitting member, a reflective member and a supporting member, wherein the reflective member includes a transforming plate and a reflective mirror plate, and the reflective mirror plate is provided with an aperture, the transforming plate and the reflective mirror plate providing on the supporting member are oppositely facing to each other, and the light-emitting member is correspondingly facing to the reflective member.

2. The reflective electrooptic lighting device as claimed in claim 1, wherein the light-emitting member has a plurality of light sources, the transforming plate is a reflective plate, and a plurality of reflect mirrors are provided on the transforming plate and/or the reflective mirror plate.

3. The reflective electrooptic lighting device as claimed in claim 1, further comprising a lens provided on the reflective mirror plate.

4. The reflective electrooptic lighting device as claimed in claim 3, further comprising a transparent plate extending outward from the reflective mirror plate.

5. The reflective electrooptic lighting device as claimed in claim 1, further comprising a subsidiary plate provided on the transforming plate.

6. The reflective electrooptic lighting device as claimed in claim 1, wherein the subsidiary plate has a reflective part and/or a transparent part.

7. The reflective electrooptic lighting device as claimed in claim 1, wherein the supporting member is a transparent cover.

8. The reflective electrooptic lighting device as claimed in claim 1, further comprising a reflective stand provided between the transforming plate and the reflective mirror plate, a reflective column provided between the transforming plate and the reflective mirror plate, and a reflective pyramid provided between the transforming plate and the reflective minor plate.

9. The reflective electrooptic lighting device as claimed in claim 1, wherein the light-emitting member including a solar light source body, the transforming plate is provided with at least one electrooptic transforming member.

10. The reflective electrooptic lighting device as claimed in claim 9, further comprising a reflective mirror provided on the back of the transforming plate.

11. The reflective electrooptic lighting device as claimed in claim 9, wherein the reflective mirror plate has a reflective part.
